(19) United States
(12) Patent Application Publication
(10) Pub. No.: US 2016/0360731 A1
(43) Pub. Date: Dec. 15, 2016

(54) PET INTERACTIVE SYSTEM BASED ON WIRELESS COMMUNICATION NETWORK

(71) Applicant: JIANGSU FAVORITE LEISURE ARTICLES CO., LTD., Jiangsu (CN)

(72) Inventor: Hao SHI, Jiangsu (CN)

(73) Assignee: JIANGSU FAVORITE LEISURE ARTICLES CO., LTD., Jiangsu (CN)

(21) Appl. No.: 15/172,129

(22) Filed: Jun. 2, 2016

(30) Foreign Application Priority Data
Jun. 2, 2015 (CN) 201510295295.4

(51) Int. Cl. A01K 15/02; A01K 29/00

(52) U.S. Cl. CPC A01K 15/025; A01K 29/005; A63H 2200/00; H04W 84/12

(57) ABSTRACT

A configuration-variable remote-controlled pet toy includes a movable base, an animal model detachably installed on the base, and an external control terminal, wherein the bottom of the base is provided with a roller wheel, the inside of the base is provided with a motor, a control circuit, a micro control unit, a wireless communication module and a phonation device; the motor is configured to drive the roller wheel to roll, the control circuit controls the rotation of the motor according to a control signal sent by the micro control unit, the wireless communication module is communicated with the external control terminal, and the phonation device is configured to play the sound or sound record of a master received by the wireless communication module in real time.

### CROSS-REFERENCE TO RELATED APPLICATIONS

This Application claims the priority of Chinese Patent Application No. 201510295295.4, filed on Jun. 2, 2015, the disclosure of which is incorporated by reference in its entirety.

### TECHNICAL FIELD

The present invention belongs to the field of pet toys, and more particularly, relates to a pet interactive system based on wireless communication network.

### BACKGROUND ART

Raising pets is very universal and common in the present society, and has become a very important way of enjoyment for people. People and pets have established an important relationship, and the intimating degree of this relationship may even beyond family affection, friendship and love sometimes because the relationship between the two is very simple but subtle. The pets as partner animals of we human beings is one resource for we human beings to gain happy and healthy life, and raising pets may make the life of people healthier and more fulfilling.

However, raising pets limits the freedom of the master to some degree; when the master needs to go out or there is nobody at home, the pets can be only kept at home for most occasions because nobody can take care of them. At this moment, most of the pets will feel lonely; although the kindheartedly master will provide some toys for the pets, but the boys cannot replace the accompanying of the master; as time passes, the physical and psychological health of the pets will be affected.

### SUMMARY OF THE INVENTION

An object of the present invention is to provide a pet interactive system based on wireless communication network which enables the masters to view the situations of the pets at any time and remotely control the pet toy to play with the pets with respect to the foregoing problems.

An object of the invention may be implemented as follows.

A pet interactive system based on wireless communication network includes a wireless camera lens, a pet toy and a control terminal.

The wireless camera lens is fixed indoors, and is configured to send shot images to the control terminal.

The inside of the pet toy is provided with a wireless communication module, a phonation module and a control module, the wireless communication module is configured to be communicated with the control terminal, the phonation module is configured to play voices from the control terminal and received by the wireless communication module in real time, and the control module is configured to control the walking of the pet toy according to a control instruction sent by the control terminal.

The control terminal is configured to receive and display the images shot by the wireless camera lens, receives the voices and control instructions of a user at the same time, and sends the voice and the control instructions to the wireless communication module of the pet toy.

Wherein, a camera lens is installed on the pet toy, and can send the shot images to the control terminal for displaying through the wireless communication module.

Wherein, the pet toy is also provided with an inductive sensor, an induction signal produced by the inductive sensor after being triggered is sent to the control terminal through the wireless communication module, and the control terminal gives out a prompting sound after receiving the induction signal.

Wherein, both the wireless communication module and the wireless camera lens realize communication connection with the control terminal through WiFi.

Wherein, the control terminal is a smartphone or a tablet.

The present invention has the advantageous effects that: through the system, the master may view the situations of the pet at home through the smartphone or tablet all the time, and remotely control the pet toy to play with the pet, and can also make the pet to hear the voice of the master through the pet toy, thus implementing the remote interaction between the master and the pet.

### BRIEF DESCRIPTION OF THE DRAWINGS

FIG. 1 is a block diagram of one embodiment of the invention.

FIG. 2 is structure block diagram in accordance with one embodiment of the invention.

### DETAILED DESCRIPTION

Embodiments of the invention will be further described in details hereinafter with reference to the drawings and specific examples.

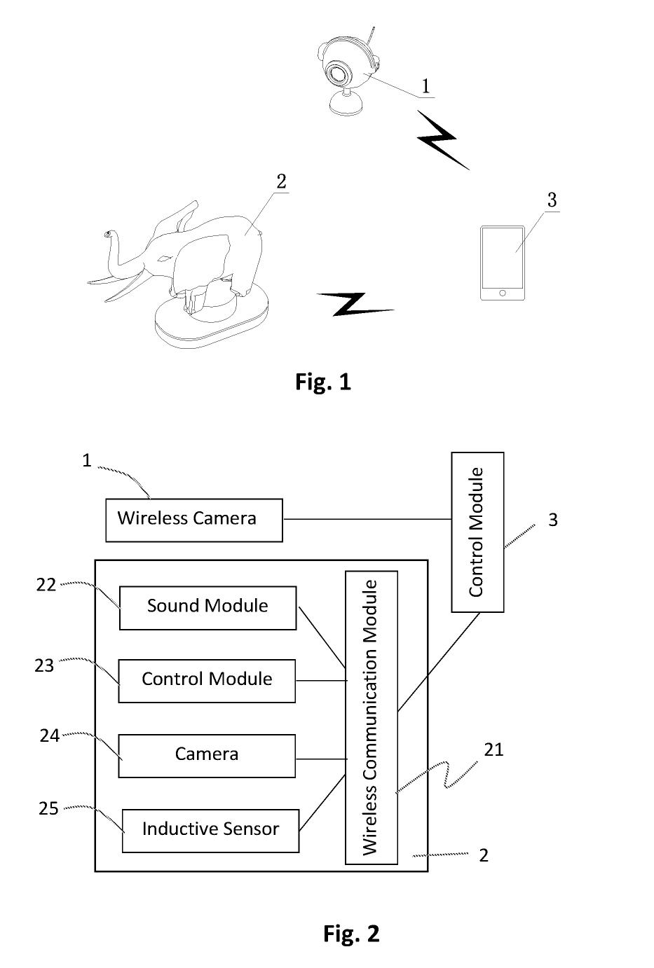

As shown in FIG. 1 and FIG. 2, a pet interactive system based on wireless communication network includes a wireless camera lens 1, a pet toy 2 and a control terminal 3.

The wireless camera lens 1 is fixed indoors, and is usually fixedly installed in a position with big viewing angle and clear visual field, for instance, a certain corner on the top of a room which can shoot the majority of the room, so as to conveniently shoot the activity situations of the pets indoors; moreover, the wireless camera lens 1 realizes communication connection with the control terminal 3 through WiFi, and sends the shot images to the control terminal 3.

The inside of the pet toy 2 is provided with a wireless communication module 21, a phonation module 22 and a control module 23. Wherein, the wireless communication module 21 is communicated with the control terminal 3 through WiFi, the phonation module 22 is configured to play voices from the control terminal 3 and received by the wireless communication module 21 in real time, and the control module 23 is configured to control the walking of the pet toy 2 according to a control instruction sent by the control terminal 3.

The control terminal 3 is generally a smartphone or a tablet, and is configured to receive and display the images shot by the wireless camera lens 1 for a user to view, receive the voices and control instructions of the user at the same time, and send the voices and the control instructions to the wireless communication module 21 of the pet toy 2. Usually, one control terminal 3 may realize the controlling of a plurality of pet toys 2.

Because the fixed wireless camera lens 1 has a dead space for shooting, a camera lens 24 is also installed on the pet toy 2, so as to conveniently view the playing situations between the pet and the pet toy 2, and the shot images can be sent to the control terminal 3 for displaying through the wireless communication module 21.

By using the system, the pet master can view the indoor activity situations of the pet through the mobile phone or tablet at anytime; meanwhile, the pet toy can be remotely controlled to run so as to attract the attention of the pet and attract the pet to play with the pet toy; moreover, a voice instruction can be given out to the pet through the mobile phone or the tablet, wherein the voice instruction will be sent to the pet toy, so that the pet toy may give out a voice instruction like the master, thus improving the attractiveness of the pet toy on the pet.

Because the master cannot view the situation of the pet at home in anytime, it is not possible to control the pet toy 2 interesting the pet to play with the pet. Therefore, the pet toy 2 is also provided with an inductive sensor 25, an induction signal produced by the inductive sensor 25 after being triggered is sent to the control terminal 3 through the wireless communication module 21, and the control terminal 3 gives out a prompting sound after receiving the induction signal. When the pet is interested to a certain pet toy 2 and walks close to the pet toy 2, the inductive sensor 25 will be triggered; at this moment, the mobile phone or tablet of the master will give out a prompting sound to prompt the master to control the pet toy 2 to walk or phonate, so as to realize the playing interaction with the pet.

What is claimed is:

1. A pet interactive system based on wireless communication network, comprising a wireless camera lens (1), a pet toy (2) and a control terminal (3), wherein:
the wireless camera lens (1) is fixed indoors, and is configured to send shot images to the control terminal (3);
the inside of the pet toy (2) is provided with a wireless communication module (21), a phonation module (22) and a control module (23), the wireless communication module (21) is configured to be communicated with the control terminal (3), the phonation module (22) is configured to play voices from the control terminal (3) and received by the wireless communication module (21) in real time, and the control module (23) is configured to control the walking of the pet toy (2) according to a control instruction sent by the control terminal (3); and
the control terminal (3) is configured to receive and display the images shot by the wireless camera lens (1), receive the voices and control instructions of a user at the same time, and sends the voices and the control instructions to the wireless communication module (21) of the pet toy (2).

2. The pet interactive system based on wireless communication network according to claim 1, wherein a camera lens (24) is installed on the pet toy (2), and can send the shot images to the control terminal (3) for displaying through the wireless communication module (21).

3. The pet interactive system based on wireless communication network according to claim 1, wherein the pet toy (2) is also provided with an inductive sensor (25), an induction signal produced by the inductive sensor (25) after being triggered is sent to the control terminal (3) through the wireless communication module (21), and the control terminal (3) gives out a prompting sound after receiving the induction signal.

4. The pet interactive system based on wireless communication network according to claim 1, wherein both the wireless communication module (21) and the wireless camera lens (1) realize communication connection with the control terminal (3) through WiFi.

5. The pet interactive system based on wireless communication network according to claim 1, wherein the control terminal (3) is a smartphone or tablet.
